(19) United States
(12) Patent Application Publication
(10) Pub. No.: US 2005/0186845 A1
(43) Pub. Date: Aug. 25, 2005

(54) Connector apparatus

(76) Inventor: Sterling D. McMurrin, Greencastle, IN (US)

Correspondence Address: STOEL RIVES LLP - SLC, 201 SOUTH MAIN STREET, ONE UTAH CENTER, SALT LAKE CITY, UT, 84111, US

(21) Appl. No.: 11/062,644

(22) Filed: Feb. 22, 2005

Related U.S. Application Data
(60) Provisional application No. 60/546,639, filed on Feb. 20, 2004.

(51) Int. Cl. H01R 13/648

(52) U.S. Cl. 439/608

(57) ABSTRACT

Disclosed are embodiments of a connector apparatus for creating a loop in a length of material, such as a cord or band, by binding the ends of the length of material together. In one embodiment of the invention, a base plate is provided having a plurality of base plate teeth extending from an interior surface thereof. The base plate further includes first and second tracks that extend to the perimeter of the base plate so as to define first and second openings in the base plate. The first and second tracks each have at least one track tooth positioned therein. The device also includes a top plate configured to be connected with the base plate.

### RELATED APPLICATIONS

This application claims the benefit under 35 U.S.C. § 119(e) of U.S. Provisional Patent Application No. 60/546,639, filed Feb. 20, 2004, and titled “Buckle Apparatus,” which is incorporated herein by specific reference.

### BRIEF DESCRIPTION OF THE DRAWINGS

Understanding that drawings depict only typical embodiments of the invention and are not therefore to be considered to be limiting of its scope, the invention will be described and explained with additional specificity and detail through the use of the accompanying drawings in which:

FIG. 1 is a perspective view of one embodiment of a connector apparatus, shown with a top plate removed.

FIG. 2 is a perspective view of the embodiment of FIG. 1, shown with a top plate connected with a base plate.

FIG. 3 is a side elevation view of an embodiment of a connector apparatus.

FIG. 4 is a perspective view of another embodiment of a connector apparatus.

FIG. 5 is a perspective view of the embodiment of FIG. 4, shown with a top plate connected with a base plate and with a male connector member connected with a female connector piece.

FIG. 6 is a perspective view of a connector piece housing of a female connector piece.

FIG. 7 is a perspective view of a release member of a female connector piece.

### DETAILED DESCRIPTION OF PREFERRED EMBODIMENTS

Described below are embodiments of a connector apparatus for creating a loop in a length of material, such as a cord or band, by binding the ends of the length of material together. The features, structures, or characteristics described herein may be combined in any suitable manner in one or more embodiments. Those skilled in the art will recognize that the invention can be practiced without one or more of the specific details, or with other methods, components, materials, etc. In other instances, well-known structures, materials, or operations are not shown or not described in detail to avoid obscuring aspects of the invention.

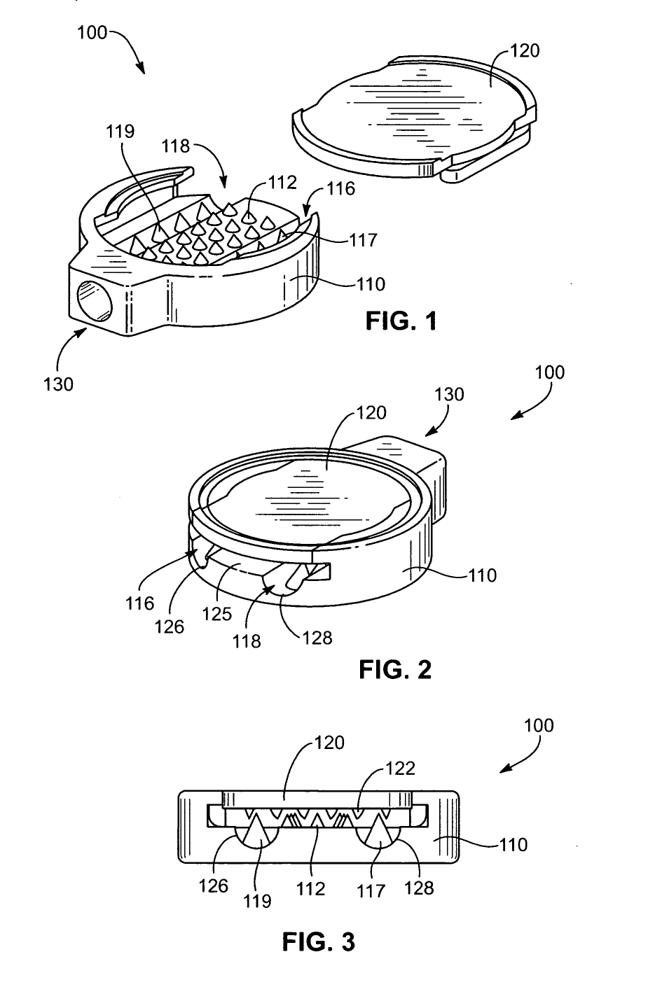

One embodiment of the invention is shown in FIGS. 1-3. As best seen in FIG. 1, connector apparatus 100 includes a base plate 110 and a top plate 120. Base plate 110 includes a plurality of base plate teeth 112 extending from an interior surface 114 of base plate 110. Base plate 110 also includes first and second tracks, 116 and 118, respectively. First track 116 includes a plurality of first track teeth 117 and second track 118 includes a plurality of second track teeth 119 disposed therein.

Connector apparatus 100 also includes a module attachment structure 130, which in this embodiment comprises a protruding member with a hole extending therethrough. Module attachment structure 130 may be threaded so as to facilitate receiving a modular attachment piece, as will be described in greater detail later.

Top plate 120 is configured to be connected with base plate 110, as shown in FIGS. 2 and 3. Top plate 120 may be connected with base plate 110 by snap-fit, press-fit, or any other connection methodology. Top plate 120 may slide or snap, for example, into place with base plate 110. As best seen in FIG. 2, upon connection of top plate 120 with base plate 110, the top plate 120 and the base plate 110 together define a slot 125 adapted to receive a band-like structure. Likewise, first track 116 and second track 118 are configured to receive the ends of a cord-like structure. The term “band-like structure” is intended to encompass any structure with a generally flat or rectangular cross-section and the term “cord-like structure” is intended to encompass any structure with a generally circular cross-section. Examples of structures suitable for use with embodiments of the disclosed connector apparatus include ropes, straps, lanyards, bands, cords, parachute cords, cotton double-ply of various sizes, poly/nylon webbing, neoprene, flat narrow webbing, etc. As best seen in FIG. 2, first and second tracks 116 and 118 extend to the perimeter of the base plate so as to define first and second openings, 126 and 128, respectively, in base plate 110.

Track teeth 117 and 119 are configured to grip a rope or other cord-like structure disposed in the respective tracks through first and second openings 126 and 128. Likewise, base plate teeth 112 are configured to grip a strap or other band-like structure disposed in the device through slot 125. Top plate 120 includes top plate teeth 122. Top plate 120 is configured such that, upon connection of top plate 120 with base plate 110, the top plate teeth 122 extend generally towards the base plate teeth. However, in the depicted embodiment, the top plate teeth 122 are offset from the base plate teeth 112. In other words, for every base plate tooth, a first top plate tooth extends towards a position on the base plate adjacent to the base plate tooth and a second top plate tooth extends towards a position on the base plate adjacent to the base plate tooth on the opposite side of the base plate tooth. This offset relationship between the various teeth can best be seen with reference to FIG. 3.

As also best seen in FIG. 3, base plate teeth 112 are smaller than track teeth 117 and 119. However, the smaller base plate teeth 112 extend to approximately the same height as the teeth 117 and 119 within the tracks. In other words, the track teeth extend from the first and second tracks to approximately the same vertical position as the position to which the base plate teeth 112 extend from base plate 110.

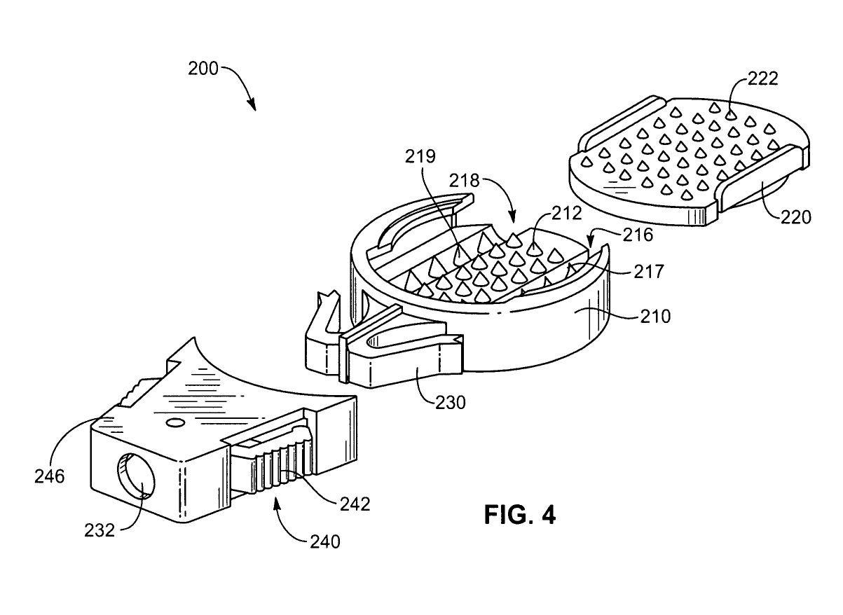

Referring now to FIGS. 4-7, an alternative embodiment of a connector apparatus is shown at 200. Connector apparatus 200 is similar to connector apparatus 100 in that it includes a base plate 210, a top plate 220, first track 216, and second track 218. Base plate 210 includes base plate teeth 212 and top plate 220 includes top plate teeth 222. Similarly, first track 216 includes one or more first track teeth 217 and second track 218 includes one or more second track teeth 219. However, in this embodiment, a male connector member 230 extends from the base plate 210. Male connector member 230 is adapted to be received in a female connector piece 240. Male connector member 230 and female connector piece 240 together comprise a buckle. As can be seen in FIG. 4, male connector member 230 includes opposing engagement members. The engagement members are flexible such that they can be temporarily deformed to allow the male connector member 230 to fit within the female connector piece 240, after which the engagement members spring back to their natural shape, thereby locking the male connector member 230 within the female connector piece 240.

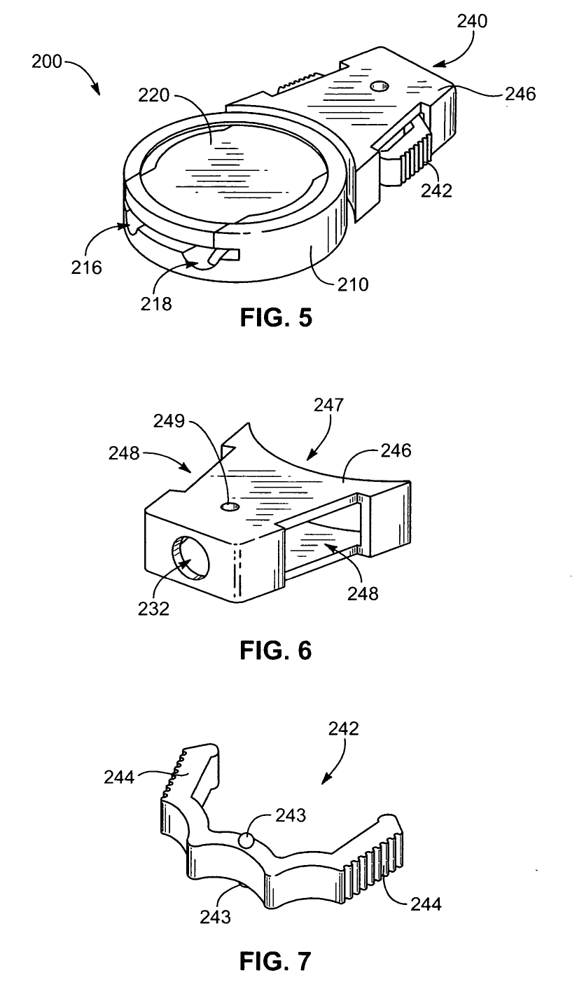

The buckle may be adapted to connect with a modular attachment piece. In some embodiments, the buckle will be adapted to engage with a modular attachment piece having a swivel connection to the female connector. Examples of suitable modular attachment pieces include ‘D’ snap-hooks, cards, clamps, bulldog clips, gator clips, pin clips, split ring holders, O ring holders, retractors, cell phone attachments, and bottle holder attachments. In the embodiment shown in FIGS. 4 and 5, female connector piece 240 includes a module attachment structure, which in this embodiment defines a hole 232. Again, hole 232 may be threaded so as to facilitate receiving any of the aforementioned modular attachment pieces.

The female connector piece 240 may be a side-detach female connector that allows for easy detachment with one hand. Female connector piece 240 includes a release member 242 disposed within a connector piece housing 246. FIGS. 6 and 7 separately illustrate these components. With reference to FIG. 6, the connector piece housing 246 is shown. Connector piece housing 246 includes a main aperture 247 and two side apertures 248, along with module attachment structure 232. Connector piece housing 246 also includes an interior depression 249, which facilitates attachment of the release member 242 with the connector piece housing 246.

Release member 242 is shown by itself in FIG. 7. Release member 242 includes engaging protrusions 243 to allow the release member to engage one or more interior depressions 249 within the female connector piece 240. In this manner, the release member is able to pivot. Release member 242 also includes grip members 244, which extend from side apertures 248 in female connector piece 240. By depressing grip members 244, release member 242 biases male connector member 230 and dislodges it from its engagement with female connector piece 240.

In some embodiments of the invention, the top plate may provide an exterior surface which can be customized with a graphic design, such as a logo, lettering, a combination of a design and lettering, or the like. The exterior surface may be designed with a logo or graphic by known techniques, such as pad print, etch, hot foil stamp, etc. The exterior surface may be configured as flat or domed. In one embodiment, the exterior surface is adapted to receive a mold insert with graphic design contained therein. An exterior surface of the base plate may also be similarly customized, if desired.

The above description fully discloses the invention including preferred embodiments thereof. Without further elaboration, it is believed that one skilled in the art can use the preceding description to utilize the invention to its fullest extent. Therefore the examples and embodiments disclosed herein are to be construed as merely illustrative and not a limitation of the scope of the present invention in any way.

It will be apparent to those having skill in the art that changes may be made to the details of the above-described embodiments without departing from the underlying principles of the invention. The scope of the present invention should, therefore, be determined only by the following claims.

1. A connector apparatus, comprising:
a base plate comprising a plurality of base plate teeth extending from an interior surface of the base plate, wherein the base plate further comprises first and second tracks, wherein the first and second tracks are configured to receive the ends of a cord-like structure, wherein the first and second tracks extend to the perimeter of the base plate so as to define first and second openings in the base plate, and wherein the first and second tracks each have at least one track tooth positioned therein; and
a top plate configured to be connected with the base plate.

2. The apparatus of claim 1, wherein the top plate further comprises a plurality of top plate teeth, wherein the top plate is configured such that, upon connection of the top plate with the base plate, the top plate teeth extend generally towards the base plate teeth.

3. The apparatus of claim 2, wherein, upon connection of the top plate with the base plate, the top plate teeth are offset from the base plate teeth such that, for every base plate tooth, a first top plate tooth extends towards a position on the base plate adjacent to the base plate tooth and a second top plate tooth extends towards a position on the base plate adjacent to the base plate tooth on the opposite side of the base plate tooth.

4. The apparatus of claim 1, wherein the first and second tracks each have a plurality of track teeth positioned therein.

5. The apparatus of claim 4, wherein the track teeth extend from the first and second tracks to approximately the same vertical position as the position to which the base plate teeth extend from the base plate.

6. The apparatus of claim 1, wherein, upon connection of the top plate with the base plate, the top plate and the base plate together define a slot adapted to receive a band-like structure.

7. The apparatus of claim 6, further comprising a band-like structure, wherein opposite ends of the band-like structure are held within the connector apparatus by the base plate teeth, and wherein the band-like structure extends out of the connector apparatus through the slot.

8. The apparatus of claim 6, further comprising a cord-like structure, wherein opposite ends of the cord-like structure are held within the connector apparatus by the track teeth, and wherein the cord-like structure extends out of the connector apparatus through the first and second openings in the base plate.

9. The apparatus of claim 1, further comprising a male connector member extending from the base plate and a female connector piece, wherein the male connector is adapted to be received in the female connector piece, and wherein the male connector member and the female connector piece together comprise a buckle.

10. The apparatus of claim 9, wherein the buckle is adapted to be connected with a modular attachment piece.

11. The apparatus of claim 1, wherein an exterior surface of the apparatus comprises a graphic design.

12. The apparatus of claim 11, wherein an exterior surface of the apparatus is adapted to receive a mold insert, and wherein the mold insert includes the graphic design.

13. A system for carrying items, the system comprising:
a base plate comprising a plurality of base plate teeth extending from an interior surface of the base plate, wherein the base plate further comprises first and second tracks, wherein the first and second tracks are configured to receive the ends of a cord-like structure, wherein the first and second tracks extend to the perimeter of the base plate so as to define first and second openings in the base plate, and wherein the first and second tracks each have a plurality of track teeth positioned therein;
a male connector member extending from the base plate;
a female connector piece, wherein the male connector is adapted to be received in an opening in the female connector piece;
a top plate configured to be connected with the base plate, wherein the top plate comprises a plurality of top plate teeth, wherein the top plate is configured such that, upon connection of the top plate with the base plate, the top plate teeth extend generally towards the base plate teeth, and wherein, upon connection of the top plate with the base plate, the top plate and the base plate together define a slot adapted to receive a band-like structure.

14. The system of claim 13, wherein the track teeth extend from the first and second tracks to approximately the same vertical position as the position to which the base plate teeth extend from the base plate.

15. The system of claim 13, wherein the female connector piece is adapted to be connected with a modular attachment piece.

16. The system of claim 15, wherein the female connector piece comprises a threaded hole to allow for connection with a threaded modular attachment piece.

17. The system of claim 13, wherein the male connector member comprises opposing engagement members, wherein the engagement members are flexible such that they can be temporarily deformed to allow the male connector member to fit within the female connector piece, after which the engagement members spring back to their natural shape, thereby locking the male connector member within the female connector piece.

18. The system of claim 13, further comprising a band-like structure, wherein opposite ends of the band-like structure are held within the connector apparatus by the base plate teeth, and wherein the band-like structure extends out of the connector apparatus through the slot.

19. The system of claim 13, further comprising a cord-like structure, wherein opposite ends of the cord-like structure are held within the connector apparatus by the track teeth, and wherein the cord-like structure extends out of the connector apparatus through the first and second openings in the base plate.

20. The system of claim 13, wherein, upon connection of the top plate with the base plate, the top plate teeth are offset from the base plate teeth such that, for every base plate tooth, a first top plate tooth extends towards a position on the base plate adjacent to the base plate tooth and a second top plate tooth extends towards a position on the base plate adjacent to the base plate tooth on the opposite side of the base plate tooth.

21. A connector apparatus, comprising:
base plate comprising a plurality of base plate teeth extending from an interior surface of the base plate, wherein the base plate further comprises first and second tracks, wherein the first and second tracks are configured to receive the ends of a cord-like structure, wherein the first and second tracks extend to the perimeter of the base plate so as to define first and second openings in the base plate, and wherein the first and second tracks each have a plurality of track teeth positioned therein; and
a top plate configured to be connected with the base plate comprising a plurality of top plate teeth, wherein the top plate is configured such that, upon connection of the top plate with the base plate, the top plate teeth extend generally towards the base plate teeth, wherein the track teeth extend from the first and second tracks to approximately the same vertical position as the position to which the base plate teeth extend from the base plate, and wherein, upon connection of the top plate with the base plate, the top plate and the base plate together define a slot adapted to receive a band-like structure.
